(19) United States
(12) Patent Application Publication
(10) Pub. No.: US 2016/0212731 A1
(43) Pub. Date: Jul. 21, 2016

(54) MAPPING BETWEEN UPLINK AND DOWNLINK RESOURCES

(71) Applicant: Microsoft Technology Licensing, LLC, Redmond, WA (US)

(72) Inventors: Yuantao Zhang, Beijing (CN); Haitao Li, Beijing (CN)

(21) Appl. No.: 14/638,317

(22) Filed: Mar. 4, 2015

(30) Foreign Application Priority Data
Jan. 21, 2015 (CN) PCT/CN2015/071240

(51) Int. Cl. H04W 72/04

(52) U.S. Cl. CPC H04W 72/04

(57) ABSTRACT

This disclosure generally relates to mapping between uplink and downlink resources. The UE may obtain a resource index indicating a first time-frequency resource which is used for transmission of data. The UE may also obtain a first band index indicating a first frequency band at which the first time-frequency resource is located. Then, the UE may determine, based on the resource index and the first band index, a resource for transmission of an acknowledgement associated with the data. In this way, an effective and efficient mapping rule between the uplink and downlink resources may be achieved.

### RELATED APPLICATIONS

This application claims priority to International Application No. PCT/CN2015/071240, filed on Jan. 21, 2015, and entitled “MAPPING BETWEEN UPLINK AND DOWNLINK RESOURCES.” This application claims the benefit of the above-identified application, and the disclosure of the above-identified application is hereby incorporated by reference in its entirety as if set forth herein in full.

### BACKGROUND

Major effort has been put in recent years on the development of Third Generation Partnership Project (3GPP) Long Term Evolution (LTE), which provides Evolved Universal Mobile Telecommunications System (UMTS) terrestrial radio access (EUTRA) and EUTRA network (EUTRAN) technology for higher data rates and system capacity.

In general, 3GPP systems can simultaneously support communication for multiple user equipment (UEs). Each UE communicates with one or more base stations (BSs) or other entities on the forward and/or reverse links. The forward link (or downlink) refers to the communication link from the BS to the UEs, and the reverse link (or uplink) refers to the communication link from the UEs to the BSs.

Some examples of UEs may be considered as machine type communication (MTC) UEs, which may include remote devices such as sensors, smart meters, location tags, wearable devices, vehicle-mounted devices, traffic congestion indication devices and the like. The MTC UE may communicate with a BS, another remote device, or some other entities. Generally, the LTE system supports many types of system bandwidths, such as 1.4 MHz, 3 MHz, 5 MHz, 10 MHz, 15 MHz and 20 MHz. For a MTC UE, a bandwidth of 1.4 MHz within a system bandwidth is specified for receiving/transmitting signals so as to reduce the complexity of the MTC UE.

### SUMMARY

Conventionally, a UE should transmit acknowledgement associated with data responsive to receiving the data from the BS. The resource for the acknowledgement may be determined based on a mapping relationship between downlink resource and associated uplink resource. In the context of the subject matter described herein, the acknowledgement includes a positive acknowledgement such as ACK and a negative acknowledgement such as NACK. In a legacy LTE system, a conventional resource mapping rule is that a scheduled Control Channel Element (CCE) of Physical Downlink Control Channel (PDCCH) may be mapped to the uplink resource for acknowledgement associated with data transmitted in Physical Downlink Shared Channel (PDSCH). However, this mapping rule in a legacy LTE system is not applicable to the MTC UE because, due to a specific bandwidth of 1.4 MHz, the MTC UE cannot decode the CCE which is transmitted in the much wider system bandwidth.

In accordance with embodiments of the subject matter described herein, the UE may obtain a resource index indicating a first time-frequency resource which is used for transmission of data. The UE may also obtain a first band index indicating a first frequency band at which the first time-frequency resource is located. Then, the UE may determine, based on the resource index and the first band index, a resource for transmission of an acknowledgement associated with the data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

FIG. 1 illustrates a block diagram of user equipment in accordance with one embodiment of the subject matter described herein;

FIG. 2 illustrates a block diagram of an environment in which embodiments of the subject matter described herein may be implemented;

FIG. 3 illustrates a flowchart of a method of mapping between uplink and downlink resources in accordance with one embodiment of the subject matter described herein;

FIG. 4 illustrates a flowchart of a method of mapping between uplink and downlink resources at the BS side in accordance with one embodiment of the subject matter described herein;

FIG. 5 illustrates a block diagram of an apparatus for contention based uplink transmission at the UE side in accordance with one embodiment of the subject matter described herein; and

FIG. 6 illustrates a block diagram of an apparatus for contention based uplink transmission at the BS side in accordance with one embodiment of the subject matter described herein.

### DETAILED DESCRIPTION

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

As used herein, the term “base station” (BS) may represent a node B (NodeB or NB), an evolved NodeB (eNodeB or eNB), a Remote Radio Unit (RRU), a radio header (RH), a remote radio head (RRH), a relay, a low power node such as a femto, a pico, and so forth.

As used herein, the term “user equipment” (UE) refers to any device that is capable of communicating with the BS. By way of example, the UE may include a terminal, a Mobile Terminal (MT), a Subscriber Station (SS), a Portable Subscriber Station (PSS), a Mobile Station (MS), or an Access Terminal (AT). Specifically, some examples of UEs include MTC devices including, but not limited to, sensors, meters, location tags, and the like. It is to be understood that embodiments of the subject matter as described herein are applicable not only to MTC devices but also to any other types of non-MTC UEs.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

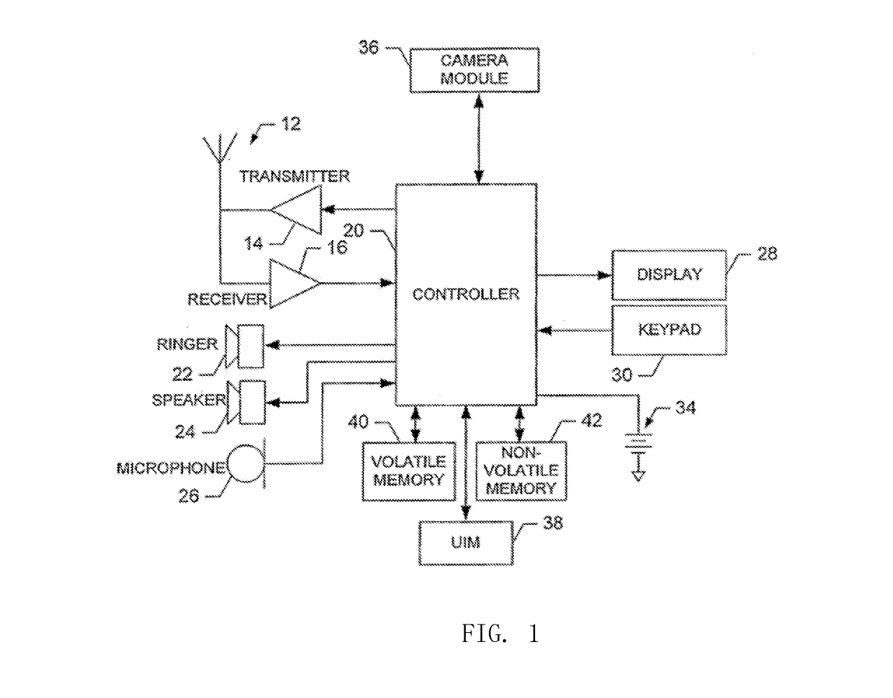

FIG. 1 illustrates a block diagram of a UE 100 in accordance with one embodiment of the subject matter described herein. In one embodiment, the UE 100 may be a MTC device with wireless communication capability. However, it is to be understood that any other types of user devices may also easily adopt embodiments of the subject matter described herein, such as a mobile phone, a portable digital assistant (PDA), a pager, a mobile computer, a mobile TV, a game apparatus, a laptop, a tablet computer, a camera, a video camera, a GPS device, and other types of voice and textual communication systems. A fixed-type device may likewise easily use embodiments of the subject matter described herein.

As shown, the UE 100 comprises one or more antennas 112 operable to communicate with the transmitter 114 and the receiver 116. With these devices, the UE 100 may perform cellular communications with one or more BSs. Specifically, the UE 100 may be configured to enhance its coverage by repeating the data transmission. That is, according to the grant and the resources allocated by the BS, the UE 100 may transmit the same uplink data multiple times.

The UE 100 further comprises at least one controller 120. It should be understood that the controller 120 comprises circuits or logic required to implement the functions of the user terminal 100. For example, the controller 120 may comprise a digital signal processor, a microprocessor, an A/D converter, a D/A converter, and/or any other suitable circuits. The control and signal processing functions of the UE 100 are allocated in accordance with respective capabilities of these devices.

Optionally, the UE 100 may further comprise a user interface, which, for example, may comprise a ringer 122, a speaker 124, a microphone 126, a display 128, and an input interface 130, and all of the above devices are coupled to the controller 120. The UE 100 may further comprise a camera module 136 for capturing static and/or dynamic images.

The UE 100 may further comprise a battery 134, such as a vibrating battery set, for supplying power to various circuits required for operating the user terminal 100 and alternatively providing mechanical vibration as detectable output. In one embodiment, the UE 100 may further comprise a user identification module (UIM) 138. The UIM 138 is usually a memory device with a processor built in. The UIM 138 may comprise a subscriber identification module (SIM), a universal integrated circuit card (UICC), a universal user identification module (USIM), a removable user identification module (R-UIM), etc. The UIM 138 may comprise a card connection detecting apparatus according to embodiments of the subject matter described herein.

The UE 100 further comprises a memory. For example, the UE 100 may comprise a volatile memory 140 comprising a volatile random access memory (RAM) in a cache area for temporarily storing data. The UE 100 may further comprise other non-volatile memory 142 which may be embedded and/or movable. The non-volatile memory 142 may additionally or alternatively include EEPROM, flash memory, etc. The memory 140 may store any item in the plurality of information segments and data used by the UE 100 so as to implement the functions of the UE 100. For example, the memory may contain machine-executable instructions which, when executed, cause the controller 120 to implement the method described below.

It should be understood that the structural block diagram in FIG. 1 is shown only for illustration purpose, without suggesting any limitations on the scope of the subject matter described herein. In some cases, some devices may be added or removed as required.

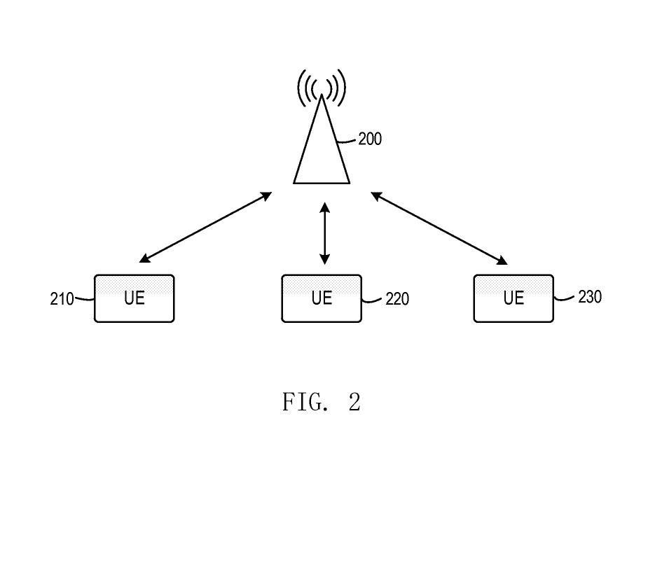

FIG. 2 shows an environment of a cellular system in which embodiments of the subject matter described herein may be implemented. As shown, one or more UEs may communicate with a BS 200. In this example, there are three UEs 210, 220 and 230. This is only for the purpose of illustration without suggesting limitations on the number of UEs. There may be any suitable number of UEs in communication with the BS 200. In one embodiment, one or more of the UEs 210, 220 and 230 may be implemented by the UE 100 as shown in FIG. 1, for example. In one embodiment, one or more of the UEs 210, 220 and 230 may be MTC UEs.

The communications between the UEs 210, 220 and 230 and the BS 200 may be performed according to any appropriate communication protocols including, but not limited to, the first generation (1G), the second generation (2G), 2.5 G, 2.75 G, the third generation (3G), the fourth generation (4G) communication protocols, and/or any other protocols either currently known or to be developed in the future.

As introduced above, a UE such as a MTC UE has to determine the resource for the acknowledgement associated with the data. The determination may be implemented based on a mapping rule between downlink resource and associated uplink resource. With a conventional resource mapping rule in a legacy LTE system, the uplink resource for acknowledgement associated with data transmitted in the PDSCH may be determined based on a scheduled CCE of the PDCCH. However, the conventional mapping rule is inefficient to the MTC. This is because the MTC UE can only communicate in a specific bandwidth of 1.4 MHz and cannot receive the PDCCH transmitted in a system bandwidth that is generally much wider.

For the MTC UE, a pair of downlink and uplink frequency bands is often allocated for transmission of data and associated acknowledgement. The allocated pair of frequency bands may be provided to the MTC UE in system information. Information on the frequency bands is useful for the MTC UE to determine the resource for the acknowledgement. In practice, in addition to the frequency bands, the MTC UE also has to know which specific time, frequency and code resources are to be used to transmit the acknowledgement. The convention mapping rule in the legacy LTE system is ineffective in this case.

Furthermore, with the increasing number of deployed MTC UEs and the imbalance between the uplink and downlink resource requirements thereof, it is possible that one allocated uplink band corresponds to more than one allocated downlink band, and vice versa. In this case, the conventional mapping rule may result in collision among the determined resources. Specifically, for example, with the same frequency band, the resources determined for different UEs may be directed to the same part of the frequency band, the same period of time, or the same code.

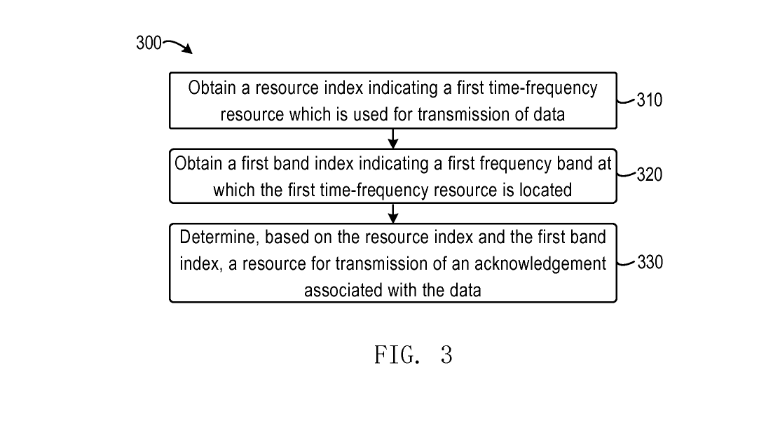

FIG. 3 shows a flowchart of a method 300 of mapping between uplink and downlink resources in accordance with one embodiment of the subject matter described herein. It would be appreciated that the method 300 may be implemented by the UE 210, 220 and/or 230 as shown in FIG. 2. For the purpose of illustration, the method 300 will be described below in terms of the UE. The method 300 may also be implemented by the BS to determine the resource for the transmission of an acknowledgement associated with data, and the details will be omitted.

The method 300 is entered at step 310, where a UE obtains a resource index indicating a time-frequency resource which is used for transmission of data. As used herein, the term “time-frequency resource” refers to a resource that occupies a period of time in the time domain and a frequency band in the frequency domain. The term “transmission” includes the uplink transmission from the UE to the BS and the downlink transmission from the BS to the UE. Accordingly, the resource mapping includes the mapping from the downlink resource to the associated uplink resource and the mapping from the uplink resource to the downlink resource.

According to embodiments of the subject matter described herein, time and frequency resources are divided into a plurality of partitions for a plurality of communications. One of the partitions may be allocated to the UE for the transmission of the data. Specifically, the allocation of the time and frequency resources may be performed by the BS, and the indication of the allocated resource is transmitted from the BS to the UE. Accordingly, the UE may use the indication as the resource index indicating the resource for the transmission of the data so as to implement the mapping of the uplink and downlink resources. According to embodiments of the subject matter described herein, the UE may obtain the indication in any suitable messages. As another example, the UE may receive the indication in broadcasting information. As an example, the broadcasting information may be carried in broadcasting signaling, such as a system information block (SIB). Alternatively or additionally, the indication may be included in Radio Resource Control (RRC) signaling or PDCCH signaling.

For the division of the time and frequency resources, any suitable division approach may be used in connection with embodiments described herein. In one embodiment, the resources may be divided into a plurality of Resource Blocks (RBs), each RB representing a time-frequency resource unit. By way of example, without limitation, a RB may occupy 0.5 ms in the time domain and 180 kHz in the frequency domain.

In this example, one or more RBs may be allocated to the UE for the transmission of the data, each of which is indicated by a block index. In one embodiment, the UE may receive the block indexes from the BS. As described above, the block indexes may be carried in any suitable messages, including, but not limited to, broadcasting signaling such as a SIB, RRC signaling, and PDCCH signaling. Upon the obtaining of the block indexes, the UE may use any suitable one of the block indexes as the resource index for the mapping of the associated uplink and downlink resources. In one embodiment, the UE may use the block index falling below a predetermined threshold. Specifically, for example, the UE uses the lowest one of the block indexes as the resource index for implementing the mapping. It is to be understood that the lowest block index is only illustrative, without suggesting any limitations on the scope of the subject matter described herein. It should be appreciated that any other block index, such as a highest block index, may also be used as the resource index utilized in the resource mapping.

In addition to the resource index indicating the time-frequency resource used for the transmission of the data, the UE also obtains a band index indicating a frequency band at which the time-frequency resource is located at step 320. According to embodiments of the subject matter described herein, the frequency resources are divided into a plurality of frequency bands, and at least one of the frequency bands is allocated to the UE for its communication. Accordingly, the time-frequency resource for the data transmission of the UE is within the allocated frequency band in the frequency domain. Any suitable allocation approach of the frequency bands may be employed. For example, in one embodiment, the frequency bands may be allocated equally based on a predetermined bandwidth. That is, each of the frequency bands has the predetermined bandwidth. As described above, for the MTC UE, a frequency band with a bandwidth of 1.4 MHz is allocated in both the uplink and the downlink. In another embodiment, the frequency bands may be allocated unequally, for example, based on user requirements.

Similar to the resource index, the UE may also obtain the band index in any suitable messages. For example, the UE may receive the band index from the BS in broadcasting signaling such as a SIB, RRC signaling, PDCCH signaling, and the like.

It should be noted that although step 310 is performed prior to step 320 in FIG. 3, it is just for the purpose of illustration without suggesting any limitation to the subject matter described herein. The sequence pattern and the shared resource may be determined in any suitable order or in parallel.

The method 300 then proceeds to step 330, where the UE determines a resource for transmission of an acknowledgement associated with the data based on the resource index and the band index obtained in steps 310 and 320. In this way, with the mapping relationship between the resource for the data and the resource for the associated acknowledgement, the UE may determine the resource for the acknowledgement based on the resource for the associated data.

As discussed above, there may be a case when more than one frequency band for the data corresponds to one frequency band for the associated acknowledgement. In this case, in order to avoid the collision among the resources in the mapping between the uplink and downlink resources, the plurality of frequency bands for the data, which correspond to the same frequency band for the acknowledgement, may be numbered such that each of the frequency bands has a corresponding number. In this example, the band index indicating the frequency band for the data is the number corresponding to the frequency band. That is, the UE determines the resource for the transmission of the acknowledgement based on the resource index indicating the frequency band used for the transmission of the data and the number corresponding to the frequency band used for the transmission of the data.

According to embodiments of the subject matter described herein, the resources for communication may include any suitable resources. Examples of the resources for communication include, but are not limited to, time resources, frequency resources and code resources. In one embodiment, the determined resource for the transmission of the acknowledgment includes time-frequency resources and code resources. Specifically, as described above, the time-frequency resources may include a plurality of RBs. In this example, the time-frequency resource for the acknowledgement may be determined by selecting one of the RBs based on the obtained resource index and band index.

In addition to the band index indicating the frequency band used for the transmission of the data, the UE may also obtain a further band index indicating a further frequency band for the transmission of the acknowledgement. Accordingly, this band index may also be used by the UE to determine the resource for the acknowledgement. Specifically, the UE can determine that the resource for the acknowledgement is within the indicated frequency band in the frequency domain. Similar to the frequency band for the transmission of the data, the further frequency band for the transmission of the associated acknowledgment may also be allocated by the BS and transmitted from the BS to the UE.

Likewise, the allocation of the further frequency band may be performed in any suitable approach. For example, the allocation may be based on a predetermined bandwidth or user requirements. Moreover, the further band index indicating the allocated frequency band may be transmitted to the UE in any suitable messages, including, for example, broadcasting signaling, such as a SIB, RRC signaling, and PDCCH signaling.

For the code resource, a plurality of sequences may be involved. A sequence is generated by a certain mathematical operation(s). Any suitable sequences may be used in connection with embodiments described herein. In one embodiment, the sequences may be implemented as constant amplitude zero auto-correlation (CAZAC) sequences. In this example, the code resource may be determined by selecting one of the sequences based on the obtained resource index and two band indexes.

In addition to the resource index and the band index obtained in steps 310 and 320, the mapping between the uplink and downlink resources may also be related to a Demodulation Reference Signal (DMRS) for demodulation of the data. In this embodiment, the UE obtains the DMRS and determines the resource for the transmission of the acknowledgement based on the resource index, the band index and the DMRS. Specifically, in the case of the mapping from the downlink to the uplink, cyclic shift of the downlink DMRS may be used as a mapping factor. In this case, the UE may receive the DMRS from the BS and detect the cyclic shift of the DMRS. In another embodiment, when the mapping from the uplink to the downlink is implemented, the scrambling sequence of the uplink DMRS may be used. In this example, the UE may select the scrambling sequence of the uplink DMRS from a configured scrambling sequence pool. Examples in this regard will be discussed below.

By way of example, the following equation illustrates an example of determining the downlink resource for the acknowledgment based on the related uplink resource:

n_{PUCCH}^{(1,\tilde{p}}^{₀}⁾=IᵤₙᵢₜI_{PRB}_{_}_{RA}_{_{—DL}}+I_{DMRS}_{_}_{SCID}+N_{PUCCH}⁽¹⁾ (1),

where Iᵤₙᵢₜ represents the band index indicating the downlink frequency band used for the transmission of downlink data, I_{PRB}_{_}_{RA}_{_}_{DL} represents the block index corresponding to the lowest physical RB of the corresponding PDSCH, I_{DMRS}_{_}_{SCID} represents the index of the scrambling code of the downlink DM-RS, and N_{PUCCH}⁽¹⁾ is a parameter configured by the system.

In this example, n_{PUCCH}^{(1,\tilde{p}}^{₀}⁾ is a parameter associated with time, frequency and code resource. Accordingly, based on the obtained n_{PUCCH}^{(1,\tilde{p}}^{₀}⁾, the resource for the acknowledgment may be determined. Specifically, for example, the CAZAC sequence as the code resource and the physical RBs as the time-frequency resource may be determined based on the n_{PUCCH}^{(1,\tilde{p}}^{₀}⁾.

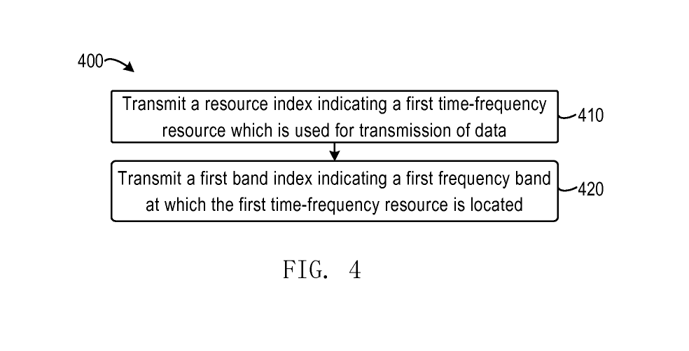

FIG. 4 illustrates a flowchart of a method 400 of mapping between uplink and downlink resources at the BS side in accordance with one embodiment of the subject matter described herein. The method 400 may be implemented at least in part by the BS, for example, the BS 200 shown in FIG. 2.

The method 400 is entered at step 410, where the BS transmits to the UE a resource index indicating the time-frequency resource which is used for the transmission of the data. As discussed above, in one embodiment, the BS may allocate the time-frequency resource to the UE for the transmission of the data. Then, the BS transmits to the UE the resource indicating the allocated time-frequency resource. According to embodiments of the subject matter described herein, the indication may be transmitted in any suitable messages. Specifically, the BS may transmit the indication in broadcasting signaling, such as a system information block (SIB). As another example, the indication may be included in RRC signaling or PDCCH signaling.

As described above, time and frequency resources are divided into a plurality of partitions for a plurality of communications. One of the partitions may be allocated to the UE for the transmission of the data. Any suitable approach of dividing the resources may be used in connection with embodiments described herein. In one embodiment, the resources may be divided into a plurality of RBs, each RB representing a time-frequency resource unit. One RB may occupy 0.5 ms in the time domain and 180 kHz in the frequency domain, for example.

In this example, one or more RBs may be allocated to the UE for the transmission of the data, each of which is indicated by a block index. The BS transmits the block indexes corresponding to the RBs to the UE. Likewise, the block indexes may be carried in any suitable messages, including, but not limited to, broadcasting signaling such as a SIB, RRC signaling, and PDCCH signaling. In this way, the UE may use one of the block indexes as a mapping factor for implementing the mapping of the associated uplink and downlink resources.

Then, the method 400 proceeds to step 420, where the BS transmits to the UE a band index indicating a frequency band at which the time-frequency resource for the transmission of the data is located. Thus, the UE may determine the resource for the transmission of the associated acknowledgement based on the band index and the resource index transmitted in step 410.

As described above, according to embodiments of the subject matter described herein, the frequency resources are divided into a plurality of frequency bands, and at least one of the frequency bands is allocated to the UE for its communication. Any suitable allocation approach of the frequency bands may be employed. For example, in one embodiment, the frequency bands may be allocated equally based on a predetermined bandwidth. That is, each of the frequency bands has the predetermined bandwidth. As described above, for the MTC UE, a frequency band with a bandwidth of 1.4 MHz is allocated in both the uplink and the downlink. In another embodiment, the frequency bands may be allocated unequally, for example, based on user requirements.

Similar to the resource index transmitted from the BS to the UE, the BS may also transmit to the UE the band index in any suitable messages. Specifically, the band index may be carried in broadcasting signaling such as a SIB, RRC signaling, PDCCH signaling, and the like.

It should be noted that although step 410 is performed prior to step 420 in FIG. 4, it is just for the purpose of illustration without suggesting any limitation to the subject matter described herein. The sequence pattern and the shared resource may be determined in any suitable order or in parallel.

As discussed above, in the case that more than one frequency band for the data corresponds to one frequency band for the associated acknowledgement, in order to avoid the collision among the resulted resources in the mapping between the uplink and downlink resources, the plurality of frequency bands for the data, which correspond to the same frequency band for the acknowledgement, may be numbered such that each of the frequency bands has a corresponding number. In this example, the BS transmits to the UE the number corresponding to the frequency band for the data transmission of the UE as the band index. In this way, the UE may determine the resource for the transmission of the acknowledgement based on the resource index indicating the frequency band used for the transmission of the data and the number corresponding to the frequency band used for the transmission of the data.

In addition to the band index indicating the frequency band used for the transmission of the data, in one embodiment, the BS may also transmit to the UE a further band index indicating a further frequency band for the transmission of the acknowledgement. Accordingly, this further band index may also be used by the UE to determine the resource for the acknowledgement. Specifically, the UE may determine that the resource for the acknowledgement is within the further frequency band indicated by the further band index in the frequency domain.

Similar to the frequency band for the transmission of the data, the further frequency band for the transmission of the associated acknowledgment may also be allocated by the BS. Likewise, the allocation of the frequency band may be performed in any suitable approach. For example, the allocation may be based on a predetermined bandwidth or user requirements. Moreover, the further band index indicating the allocated frequency band may be transmitted from the BS to the UE in any suitable messages, including, for example, broadcasting signaling, such as a SIB, RRC signaling, and PDCCH signaling.

According to embodiments of the subject matter described herein, the resources for communication may include any suitable resources. Examples of the resources for communication include, but are not limited to, time resources, frequency resources and code resources. In one embodiment, the determined resource for the transmission of the acknowledgment includes time-frequency resources and code resources. Specifically, the time-frequency resources may include a plurality of RBs. For the code resource, a plurality of sequences may be involved, for example. As described above, a sequence is generated by a certain mathematical operation(s). Any suitable sequences may be used in connection with embodiments described herein. In one embodiment, the sequences may be implemented as CAZAC sequences. In this example, the UE may determine the time-frequency resource and code resource for the acknowledgement based on the resource index indicating the time-frequency resource used for the transmission of the data, and the band index indicating the frequency band that corresponds to the time-frequency resource for the data, and the further band index indicating the further frequency band for the transmission of the acknowledgement.

As described above, in the context of the subject matter described above, the transmission includes the uplink transmission from the UE to the BS and the downlink transmission from the BS to the UE. Accordingly, the resource mapping includes the mapping from the downlink resource to the associated uplink resource and the mapping from the uplink resource to the downlink resource. In the case of the mapping from the downlink resource to the associated uplink resource, in one embodiment, the BS transmits to the UE a DMRS that may also be used by the UE to determine the resource for the transmission of the acknowledgement. Specifically, the cyclic shift of the downlink DMRS may be used as a mapping factor when the UE implements the mapping from the downlink resources to the uplink resources.

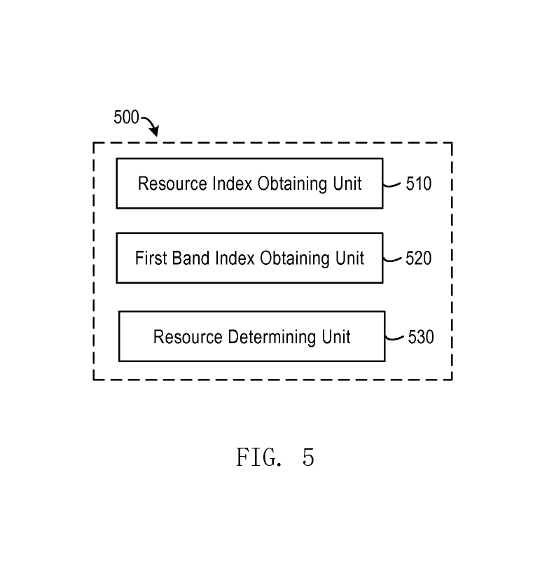

FIG. 5 shows a block diagram of an apparatus 500 for mapping between uplink and downlink resources at the UE side in accordance with one embodiment of the subject matter described herein. As shown, the apparatus 500 comprises: a resource index obtaining unit 510 configured to obtain a resource index indicating a first time-frequency resource which is used for transmission of data; a first band index obtaining unit 520 configured to obtain a first band index indicating a first frequency band at which a first time-frequency resource is located; and a resource determining unit 530 configured to determine a resource for transmission of an acknowledgement associated with the data based on the resource index and the first band index.

In one embodiment, the first time-frequency resource includes a first plurality of resource blocks corresponding to a plurality of block indexes. In this embodiment, the resource index obtaining unit 510 comprises a resource index determining unit configured to select one of the block indexes which is below a predetermined threshold as the resource index.

In one embodiment, the resource determining unit 530 comprises a DMRS obtaining unit configured to obtain a DMRS for demodulation of the data; and a first resource determining unit configured to determine the resource based on the resource index, the first band index and the DMRS.

In one embodiment, the resource determining unit 530 comprises a second band index obtaining unit configured to obtain a second band index indicating a second frequency band for the transmission of the acknowledgement; and a first resource determining unit configured to determine one of a second time-frequency resource and a code resource as the resource based on the resource index and the first and second band indexes.

In one embodiment, the second frequency band is associated with the first frequency band and a third frequency band for transmission of further data, the first frequency band being associated with a first number and the third frequency band being associated with a second number. In this embodiment, the first band index obtaining unit 520 comprises a band index determining unit configured to obtain the first number as the first band index.

In one embodiment, the second time-frequency resource includes a second plurality of resource blocks, and the code resource includes a plurality of sequences. In this embodiment, the resource determining unit 530 comprises a time-frequency resource determining unit configured to select one of the second plurality of resource blocks as the second time-frequency resource based on the resource index and the first and second band indexes; and the code resource determining unit configured to select one of the sequences as the code resource based on the resource index and the first and second band indexes.

In one embodiment, the transmission of the data includes downlink transmission of the data from the BS to the UE, or uplink transmission of the data from the UE to the BS.

In one embodiment, the indexes are obtained by one of broadcasting information, RRC signaling and PDCCH signaling.

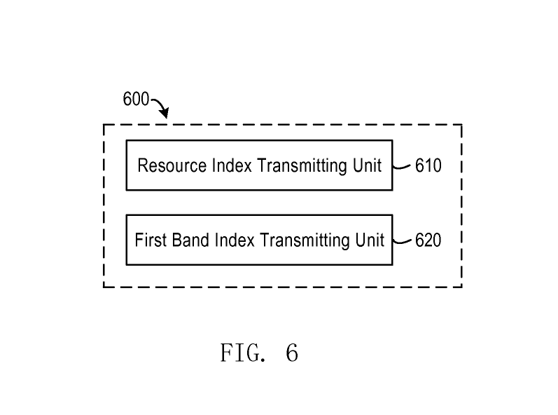

FIG. 6 shows a block diagram of an apparatus 600 for mapping between uplink and downlink resources at the BS side in accordance with embodiments of the subject matter described herein. As shown, the apparatus 600 comprises a resource index transmitting unit 610 configured to transmit to the UE a resource index indicating a first time-frequency resource which is used for transmission of data; and a first band index transmitting unit 620 configured to transmit to the UE a first band index indicating a first frequency band at which the first time-frequency resource is located, such that the UE determines a resource for transmission of an acknowledgement associated with the data based on the resource index and the first band index.

In one embodiment, the first time-frequency resource includes a first plurality of resource blocks corresponding to a plurality of block indexes. In one embodiment, the resource index transmitting unit 610 comprises a block index transmitting unit configured to transmit the plurality of block indexes to the UE.

In one embodiment, the apparatus 600 comprises a second band index transmitting unit configured to transmit to the UE a second band index indicating a second frequency band for the transmission of the acknowledgement, such that the UE determines one of a second time-frequency resource and a code resource as the resource for the transmission of the acknowledgement based on the resource index and the first and second band indexes.

In one embodiment, the second frequency band is associated with the first frequency band and a third frequency band for transmission of further data, the first frequency band being associated with a first number and the third data frequency band being associated with a second number. In this embodiment, the first band index transmitting unit 620 comprises a number transmitting unit configured to transmit to the UE the first number as the first band index.

In one embodiment, the transmission of the data includes downlink transmission of the data from the BS to the UE. In this embodiment, the apparatus 600 comprises a DMRS transmitting unit configured to transmit to the UE a DMRS for demodulation of the data.

In one embodiment, the transmission of the data includes uplink transmission of the data from the UE to the BS.

In one embodiment, the indexes are transmitted to the UE by one of broadcasting information, RRC signaling and PDCCH signaling.

The units included in the apparatuses 500 and/or 600 may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses 500 and/or 600 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the subject matter described herein may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the subject matter described herein are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the subject matter can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
obtaining, at a user equipment (UE), a resource index indicating a first time-frequency resource that is used for transmission of data;
obtaining, at the UE, a first band index indicating a first frequency band at which the first time-frequency resource is located; and
determining, at the UE and based on the resource index and the first band index, a resource for transmission of an acknowledgement associated with the data.

2. The method according to claim 1, wherein the first time-frequency resource includes a first plurality of resource blocks corresponding to a plurality of block indexes, and wherein obtaining a resource index comprises:
selecting one of the block indexes that is below a predetermined threshold as the resource index.

3. The method according to claim 1, wherein determining a resource for transmission of the acknowledgement comprises:
obtaining a Demodulation Reference Signal (DMRS) for demodulation of the data; and
determining the resource for transmission of the acknowledgement based on the resource index, the first band index and the DMRS.

4. The method according to claim 1, wherein determining a resource for transmission of the acknowledgement comprises:
obtaining a second band index indicating a second frequency band for the transmission of the acknowledgement; and
determining one of a second time-frequency resource and a code resource as the resource for transmission of the acknowledgement based on the resource index and the first and second band indexes.

5. The method according to claim 4, wherein the second frequency band is associated with the first frequency band and a third frequency band for transmission of further data, the first frequency band being associated with a first number and the third frequency band being associated with a second number, and wherein obtaining a first band index indicating a first frequency band comprises:
obtaining the first number as the first band index.

6. The method according to claim 4, wherein the second time-frequency resource includes a second plurality of resource blocks, and wherein determining one of a second time-frequency resource and a code resource as the resource for transmission of the acknowledgement comprises:
selecting one of the second plurality of resource blocks as the second time-frequency resource based on the resource index and the first and second band indexes.

7. The method according to claim 4, wherein the code resource includes a plurality of sequences, and wherein determining one of a second time-frequency resource and a code resource as the resource for transmission of the acknowledgement comprises:
selecting one of the sequences as the code resource based on the resource index and the first and second band indexes.

8. The method according to claim 1, wherein the transmission of the data includes one of downlink transmission of the data from a base station (BS) to the UE, and uplink transmission of the data from the UE to the BS.

9. The method according to claim 1, wherein the indexes are obtained by one of broadcasting information, Radio Resource Control (RRC) signaling and Physical Downlink Control Channel (PDCCH) signaling.

10. A method comprising:
transmitting, from a base station (BS) to a user equipment (UE), a resource index indicating a first time-frequency resource that is used for transmission of data; and
transmitting, from the BS to the UE, a first band index indicating a first frequency band at which the first time-frequency resource is located, such that the UE determines a resource for transmission of an acknowledgement associated with the data based on the resource index and the first band index.

11. The method according to claim 10, wherein the first time-frequency resource includes a first plurality of resource blocks corresponding to a plurality of block indexes, the transmitting a resource index comprises:
transmitting the plurality of block indexes to the UE.

12. The method according to claim 11, further comprising:
transmitting to the UE a second band index indicating a second frequency band for the transmission of the acknowledgement, such that the UE determines the resource for the transmission of the acknowledgement based on the resource index and the first and second band indexes.

13. The method according to claim 12, wherein the second frequency band is associated with the first frequency band and a third frequency band for transmission of further data, the first frequency band being associated with a first number and the third data frequency band being associated with a second number, and wherein the transmitting a first band index comprises:
transmitting to the UE the first number as the first band index.

14. The method according to claim 10, wherein the transmission of the data includes downlink transmission of the data from the BS to the UE, the method further comprising:
transmitting to the UE a Demodulation Reference Signal (DMRS) for demodulation of the data.

15. The method according to claim 10, wherein the transmission of the data includes uplink transmission of the data from the UE to the BS.

16. The method according to claim 10, wherein the indexes are transmitted to the UE by one of broadcasting information, Radio Resource Control (RRC) signaling and Physical Downlink Control Channel (PDCCH) signaling.

17. A user equipment (UE) comprising:
a receiver configured to
receive a first band index indicating a first frequency band at which a first time-frequency resource is located, the first time-frequency resource being used for transmission of data, and
receive a second band index indicating a second frequency band for transmission of an acknowledgement associated with the data; and
a controller configured to
obtain a resource index indicating the first time-frequency resource, and
determine, based on the first and second band indexes and the resource index, one of a second time-frequency resource and a code resource for the transmission of the acknowledgement.

18. The UE according to claim 17, wherein the first time-frequency resource includes a plurality of first resource blocks corresponding to a plurality of block indexes, and wherein
the receiver is further configured to receive the plurality of block indexes; and
the controller is configured to select one of the block indexes which is below a predetermined threshold as the resource index.

19. The UE according to claim 17, wherein the transmission of the data includes downlink transmission of the data from a base station (BS) to the UE, and wherein
the receiver is further configured to receive a Demodulation Reference Signal (DMRS) for demodulation of the data; and
the controller is configured to determine the resource based on the resource index, the first and second band indexes and the DMRS.

20. The UE according to claim 17, wherein the second frequency band is associated with the first frequency band and a third frequency band for transmission of further data, the first frequency band being associated with a first number and the third frequency band being associated with a second number, and wherein the receiver is configured to receive the first number as the first band index.
